(19) United States
(12) Patent Application Publication
(10) Pub. No.: US 2026/0116691 A1
(43) Pub. Date: Apr. 30, 2026

(54) CONVEYANCE APPARATUS FOR INHIBITING SKEW OF A LONG SHEET MEDIUM

(71) Applicant: BROTHER KOGYO KABUSHIKI KAISHA, Nagoya (JP)

(72) Inventors: Hideaki YOSHIMUNE, Nagoya (JP); Yuya TATEMATSU, Nagoya (JP)

(73) Assignee: BROTHER KOGYO KABUSHIKI KAISHA, Nagoya (JP)

(21) Appl. No.: 19/370,971

(22) Filed: Oct. 28, 2025

(30) Foreign Application Priority Data
Oct. 31, 2024 (JP) 2024-191801

(51) Int. Cl. B65H 23/04; B41J 11/00

(52) U.S. Cl. CPC B65H 23/04; B41J 11/0055; B65H 2801/12

(57) ABSTRACT

A conveyance apparatus includes a sheet placement assembly and a sheet conveyor configured to convey a sheet medium on the sheet placement assembly in a conveyance direction. The sheet placement assembly, when in a first state extending vertically, receives the sheet medium in a folded manner at its upper end. The sheet placement assembly includes a first opposing surface facing a downstream portion, in the conveyance direction, of the sheet medium on the sheet placement assembly in the first state, a second opposing surface facing an upstream portion, in the conveyance direction, of the sheet medium on the sheet placement assembly in the first state, and a plurality of first regulation members disposed such that the upstream portion of the sheet medium is between the first regulation members in a particular direction intersecting the conveyance direction and configured to regulate movement of the sheet medium in the particular direction.

### REFERENCE TO RELATED APPLICATIONS

This application claims priority from Japanese Patent Application No. 2024-191801 filed on October 31, 2024. The entire content of the priority application is incorporated herein by reference.

### BACKGROUND ART

An image forming apparatus has been known that includes a sheet feed table configured to support a sheet placed thereon, and two side fences configured to guide both lateral ends of the sheet placed on the sheet feed table in a width direction orthogonal to a conveyance direction in which the sheet is conveyed. Each of the side fences includes an extension side fence. Each extension side fence is extendable and contractible along the conveyance direction from an end of the corresponding side fence. This configuration enables both lateral ends of the sheet placed on the sheet feed table to be guided by the extension side fences, even when the sheet has a large length in the conveyance direction.

### SUMMARY

In the known configuration, the two side fences and the extension side fences are configured to primarily guide both lateral ends (i.e., both ends in the width direction) of the sheet placed on the top surface of the sheet feed table. When a longer sheet medium is placed while being folded in such a manner that the sheet medium faces both the top surface and the opposite surface of the sheet feed table, both lateral ends of a downstream portion of the sheet medium in the conveyance direction are primarily guided by the side fences and the extension side fences. However, both lateral ends of an upstream portion of the long sheet medium in the conveyance direction are not guided. In such a case, skewing of the sheet medium during conveyance is likely to easily occur due to lateral displacement of the upstream portion.

Aspects of the present disclosure are advantageous in providing one or more improved techniques for enabling a conveyance apparatus to inhibit skewing of a long sheet medium.

According to aspects of the present disclosure, a conveyance apparatus is provided, which includes a sheet placement assembly and a sheet conveyor. The sheet placement assembly is configured to, when in a first state where the sheet placement assembly extends in a vertical direction, receive a sheet medium placed thereon in a folded manner at an upper end of the sheet placement assembly. The sheet conveyor is configured to convey the sheet medium received on the sheet placement assembly in a conveyance direction. The sheet placement assembly includes a first opposing surface, a second opposing surface, and a plurality of first regulation members. The first opposing surface faces a downstream portion, in the conveyance direction, of the sheet medium received on the sheet placement assembly in the first state. The second opposing surface faces away from the first opposing surface and faces an upstream portion, in the conveyance direction, of the sheet medium received on the sheet placement assembly in the first state. The plurality of first regulation members are disposed such that the upstream portion of the sheet medium, facing the second opposing surface, is between the plurality of first regulation members in a particular direction intersecting the conveyance direction. The plurality of first regulation members are configured to regulate movement of the sheet medium in the particular direction.

### BRIEF DESCRIPTION OF DRAWINGS

FIG. 1 is a perspective view of a printer.

FIG. 2 is a schematic side view, partially shown in cross section, illustrating an internal configuration of the printer.

FIG. 3 is an enlarged view of a region III in FIG. 2.

FIG. 4A is a front view of a movable portion of a sheet placement assembly in FIG. 3.

FIG. 4B is a rear view of the movable portion.

FIG. 5A is a cross-sectional plan view of the movable portion taken along a line V–V in FIG. 4A.

FIG. 5B illustrates a state in which each of respective movable guide portions 89B of two side guides 89 in FIG. 5A is folded from a first position to a second position.

FIG. 6A is a cross-sectional plan view of the movable portion taken along a line VI–VI in FIG. 4A.

FIG. 6B illustrates a state in which respective movable guide portions 88B of two side guides 88 and the respective movable guide portions 89B of the side guides 89 in FIG. 6A are moved along a left-right direction.

FIG. 7A is an enlarged view from the right of a printer, partially illustrating a sheet placement assembly of the printer when a movable portion of the sheet placement assembly is in a vertical state.

FIG. 7B is an enlarged view partially illustrating the movable portion in the vertical state as viewed from the front.

### DESCRIPTION

It is noted that various connections are described between elements in the following description. These connections, unless specified otherwise, may be either direct or indirect, and this specification is not intended to be limiting in that respect.

In the present disclosure, an inclusive OR — meaning that it includes either A, B, or both — may be expressed as “A and/or B,” “at least one of A or B,” or “at least one selected from the group consisting of A and B.” Additionally, the expression “one of A or B,” as used herein, refers to a case where A or B is selected exclusively, but not both. The same interpretation applies in cases where three or more selectable elements are considered.

### First Illustrative Embodiment

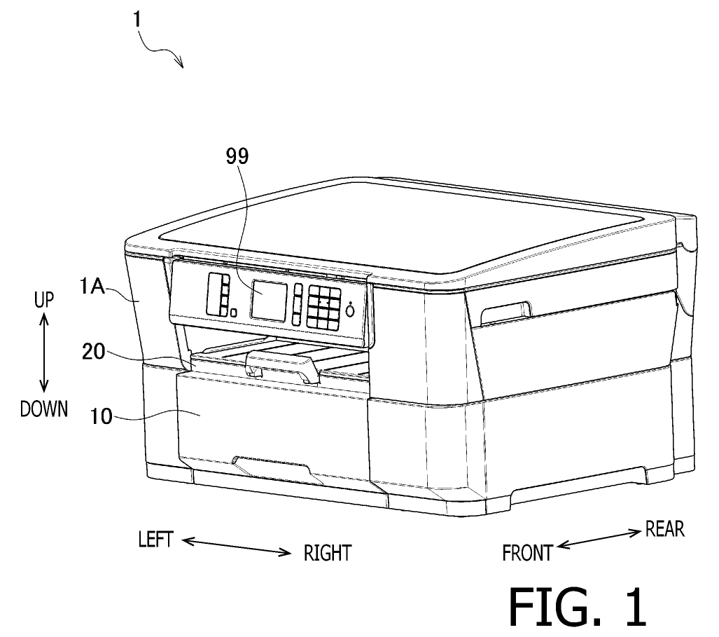

A printer 1 of a first illustrative embodiment according to aspects of the present disclosure includes, as illustrated in FIG. 1, a housing 1A, a feed tray 10 configured to be detachably attached to the housing 1A, and a discharge tray 20. The printer 1 may be an example of a “conveyance apparatus” according to aspects of the present disclosure.

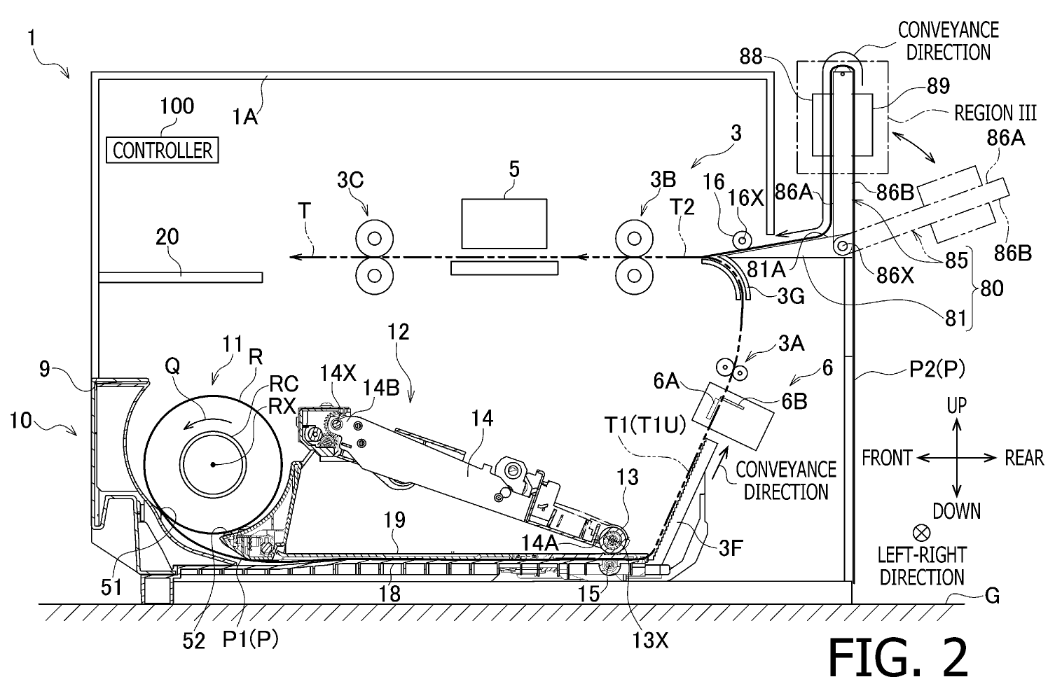

As illustrated in FIG. 2, the printer 1 further includes a sheet conveyor 3, a head 5, a cutter 6, a sheet placement assembly 80, a notification device 99, and a controller 100. The sheet conveyor 3, the head 5, the cutter 6, the sheet placement assembly 80, and the controller 100 are supported by the housing 1A.

In the following description, the vertical directions (i.e., the upward direction and the downward direction) are defined based on a state (see FIG. 2) in which the printer 1 is installed on an installation surface G in a usable manner. The front-rear directions (i.e., the frontward direction and the rearward direction) are defined with the front side being a side of the housing 1A where an opening 9 is formed, and the rear side being a side where the sheet placement assembly 80 is disposed. The left-right directions (i.e., the leftward direction and the rightward direction) are defined based on the left and right as viewed from the front side of the printer 1. Hereinafter, a representative one of the vertical directions may be referred to as “the vertical direction” in the singular form for the sake of explanatory simplicity. The same applies to the front-rear directions and the left-right directions.

The sheet conveyor 3 is configured to convey a sheet P along a conveyance path T in a conveyance direction. The sheet conveyor 3 includes a roller 13 and an arm 14, roller sets 3A to 3C, a separation member 3F, two guide members 3G, a roller 16, and a conveyance motor (not shown) configured to drive these rollers. Each of the roller sets 3A to 3C includes two rollers, and may be referred to as “two rollers 3A, 3B or 3C.”

The conveyance path T includes a path T1 and a path T2. The path T1 extends from the feed tray 10 toward the discharge tray 20, passing between the two guide members 3G and under the head 5. The path T2 extends from the sheet placement assembly 80 toward the discharge tray 20, passing under the head 5. The path T1 includes a U-shaped section T1U located upstream of the head 5 in the conveyance direction. The separation member 3F, the cutter 6, the two rollers 3A, and the two guide members 3G are arranged along the U-shaped section T1U. The path T2 is defined as a portion downstream of the two guide members 3G in the path T1, and extends linearly in the front-rear direction.

The feed tray 10 is configured to be removably attached to the housing 1A and to be movable forward through the opening 9 from the attached state. The feed tray 10 includes rollers 51 and 52, a roll sheet housing 11 configured to accommodate a roll sheet R, and a cut sheet housing 12 configured to accommodate a plurality of cut sheets (not shown) stacked in the vertical direction. The cut sheets stored in the cut sheet housing 12 are supported on an upper surface of a support plate 19 that is disposed along a bottom plate 18 of the feed tray 10. In the feed tray 10, the cut sheets are removed from the cut sheet housing 12 when the roll sheet R is used (see FIG. 2), whereas the roll sheet R is removed from the roll sheet housing 11 when the cut sheets are used.

The term “sheet P” collectively refers to a sheet P1 unwound from the roll sheet R, a cut sheet, a sheet P2 that is longer in the conveyance direction than the cut sheet, a postcard, or an envelope. These may be included as examples of a “sheet medium” according to aspects of the present disclosure. The cut sheet refers to a sheet having a length along the conveyance path T that is shorter than the length of a sheet forming the roll sheet R. The sheet P2 may include a portion of the sheet P1 that has been cut by the cutter 6 and discharged into the discharge tray 20.

The roll sheet R is formed by winding a long sheet P1 in a roll around an outer circumferential surface of a cylindrical core member RC. The roll sheet R is stored in the roll sheet housing 11 with its rotation axis RX (i.e., the center axis of the core member RC) aligned with the left-right direction.

The rollers 51 and 52 are disposed at the bottom of the roll sheet housing 11. The rollers 51 and 52 are driven rollers, each configured to rotate about a shaft extending in the left-right direction. When the roll sheet R is stored in the roll sheet housing 11, a lower portion of the outer circumferential surface of the roll sheet R is supported by the rollers 51 and 52. To set the roll sheet R, the user manually rotates the roll sheet R in the direction indicated by an arrow Q in FIG. 2, thereby unwinding the sheet P1 from the roll sheet R. The sheet P1 is then passed through a gap between a lower surface (i.e., a downward-facing surface) of the support plate 19 and an upper surface (i.e., an upward-facing surface) of the bottom plate 18. A leading end of the sheet P1 is inserted between the roller 13 and a driven roller 15. In this state, the conveyance motor is driven under the control of the controller 100 to rotate the roller 13, thereby feeding the sheet P1 unwound from the roll sheet R rearward.

The roller 13 is supported at one end 14A of the arm 14 and is configured to rotate about a shaft 13X extending in the left-right direction. The other end 14B of the arm 14 is supported by the housing 1A via a shaft 14X extending in the left-right direction. The arm 14 is pivotable about the shaft 14X, with the other end 14B serving as a fulcrum.

When the feed tray 10 is attached to the housing 1A and no cut sheets are stored in the cut sheet housing 12, the roller 13 is in contact with the driven roller 15 through a cutout (not shown) in the support plate 19 (see FIG. 2). When the feed tray 10 is attached to the housing 1A and cut sheets are stored in the cut sheet housing 12, the roller 13 is in contact with an uppermost one of the cut sheets stored in the cut sheet housing 12. In this case, the conveyance motor is driven under the control of the controller 100 to rotate the roller 13, thereby feeding the cut sheet rearward.

The sheet P (e.g., a sheet P1 unwound from the roll sheet R or a cut sheet) that has been fed from the feed tray 10 by the roller 13 comes into contact with the separation member 3F and is conveyed along the separation member 3F to be guided to the two rollers 3A.

The separation member 3F is disposed rearward of the roller 13 and extends in an oblique direction intersecting both the vertical direction and the front-rear direction. The surface of the separation member 3F has fine irregularities repeatedly formed along the path T1. These irregularities inhibit double feeding, in which a plurality of cut sheets are conveyed in a stacked state. Thus, the separation member 3F is configured to separate a cut sheet in contact with the roller 13 from the other cut sheets.

The roller sets 3A to 3C are arranged in this order from the upstream side in the conveyance direction. The roller sets 3A to 3C are configured to convey the sheet P fed by the roller 13 in the conveyance direction. The roller set 3A (i.e., the two rollers 3A) is disposed between the cutter 6 and the two guide members 3G in the conveyance direction. The roller set 3A is configured to guide the sheet P fed by the roller 13 to the roller set 3B.

The roller set 3B (i.e., the two rollers 3B) is configured to convey the sheet P (e.g., a sheet P1 unwound from the roll sheet R, a cut sheet, a sheet P2 that is longer in the conveyance direction than the cut sheet, a postcard, or an envelope) to the head 5. The roller set 3C (i.e., the two rollers 3C) is configured to discharge the sheet P conveyed by the roller set 3B onto the discharge tray 20. The sheet P conveyed by the roller sets 3B and 3C is delivered forward.

Each of the roller sets 3A to 3C includes a driving roller and a driven roller. The driving roller is configured to rotate in response to a driving force from the conveyance motor. The driven roller is configured to be rotated in conjunction with the rotation of the driving roller. When the conveyance motor is driven under the control of the controller 100, the driving roller and the driven roller of each of the roller sets 3A to 3C rotate while nipping the sheet P therebetween, thereby conveying the sheet P in the conveyance direction.

The roller 16 is disposed on the sheet placement assembly 80. The roller 16 is configured to rotate about a shaft 16X extending in the left-right direction. The roller 16 is further configured to come into contact with an upper surface of the sheet P (e.g., a cut sheet, a sheet P2 that is longer in the conveyance direction than the cut sheet, a postcard, or an envelope) received on the sheet placement assembly 80. In this case, the conveyance motor is driven under the control of the controller 100 to rotate the roller 16, thereby feeding the sheet P forward. The sheet P fed from the sheet placement assembly 80 by the roller 16 is guided to the roller set 3B.

The head 5 includes a plurality of nozzles (not shown) formed in a lower surface thereof and a driver IC (not shown). When the sheet P conveyed by the sheet conveyor 3 passes a position facing the lower surface of the head 5, the driver IC is operated under the control of the controller 100, causing ink to be ejected from the nozzles. The ink lands on the sheet P, and an image is recorded on the sheet P. The head 5 may be a line-type head configured to eject ink from the nozzles with its position fixed, or a serial-type head configured to eject ink from the nozzles while moving along the left-right direction.

The cutter 6 is disposed downstream of the separation member 3F and upstream of the roller set 3A in the conveyance direction. The cutter 6 is configured to cut the sheet P1 unwound from the roll sheet R at a position along the path T1 between the separation member 3F and the roller set 3A. The cutter 6 includes a fixed blade 6A that extends in the left-right direction, and a disk-shaped rotary blade 6B configured to move in the left-right direction while being in contact with the fixed blade 6A. When a cutter motor is driven under the control of the controller 100, the rotary blade 6B moves in the left-right direction and simultaneously rotates in response to a driving force from the cutter motor. The sheet P1 unwound from the roll sheet R is cut in the width direction (i.e., the left-right direction) by the fixed blade 6A and the rotary blade 6B that is rotating while moving in the left-right direction.

As illustrated in FIG. 2, the sheet placement assembly 80 is disposed at an upstream portion of the path T2 in the conveyance direction and is configured to convey the sheet P placed thereon. The sheet placement assembly 80 includes a chute 81 and a movable portion 85 supported at a rear end portion of the chute 81.

The chute 81 is disposed below the roller 16 and extends in the front-rear direction. The chute 81 has an upper surface 81A that slopes downward toward the front. Thus, the chute 81 is configured to guide the sheet P received on the sheet placement assembly 80 to the roller set 3B.

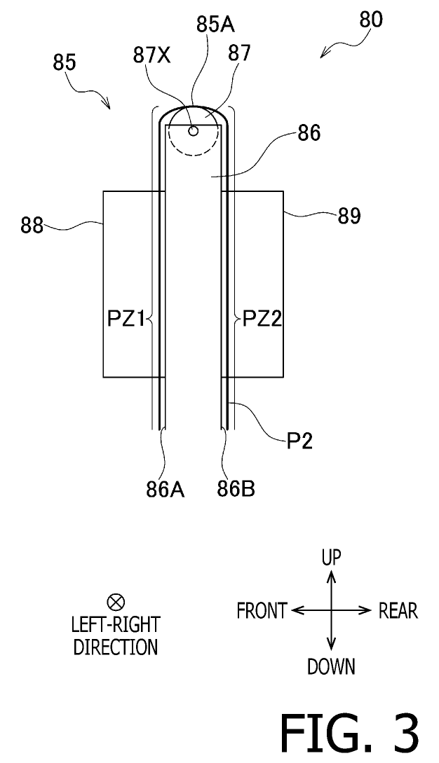

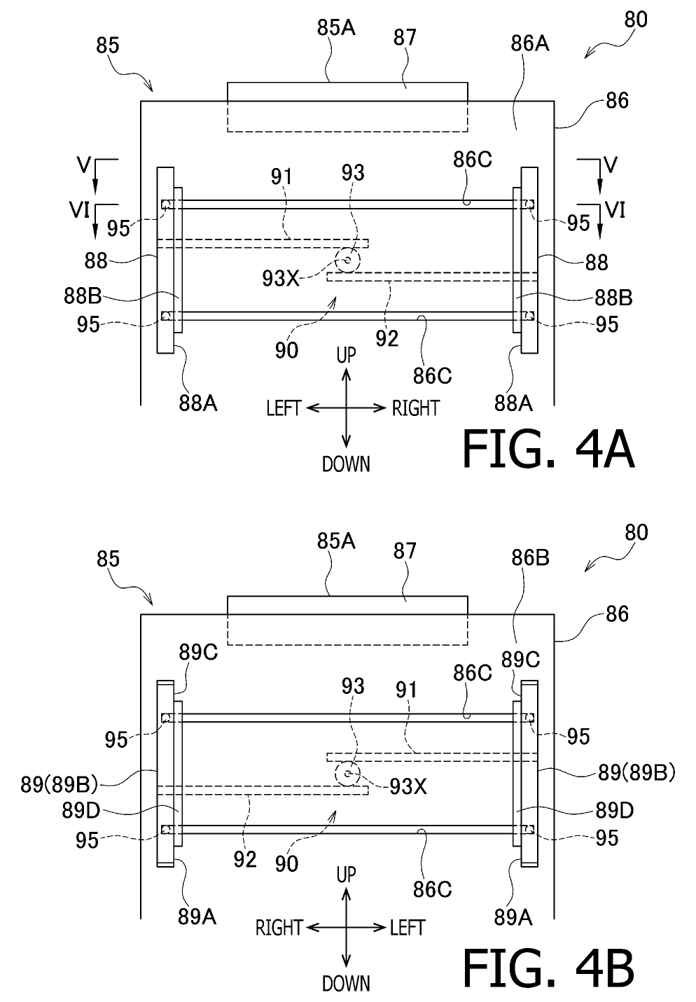

As illustrated in FIGS. 3, 4A, and 4B, the movable portion 85 includes a main body 86, a roller 87, two side guides 88, two side guides 89, a movement mechanism 90, and four connecting portions 95. The main body 86 extends in both the vertical direction and the left-right direction. The roller 87 extends in the left-right direction and is disposed at an upper end portion of the main body 86. As illustrated in FIGS. 4A and 4B, in the left-right direction, the center of the roller 87 aligns with the center of the main body 86. As illustrated in FIG. 3, the roller 87 is supported by the main body 86 to be rotatable about a shaft 87X extending in the left-right direction.

The main body 86 includes a first opposing surface 86A and a second opposing surface 86B. As illustrated in FIG. 2, the main body 86 is supported to be rotatable about a shaft 86X extending in the left-right direction. The movable portion 85 is configured to selectively assume either a vertical state or an inclined state. In other words, the movable portion 85 is movable between the vertical state and the inclined state. In the vertical state, the main body 86 extends vertically, as shown by a solid line in FIG. 2. In the inclined state, the main body 86 extends obliquely relative to the vertical direction, as shown by a double-dashed chain line in FIG. 2.

As illustrated in FIG. 2, when the sheet P2 is received on the sheet placement assembly 80 with the movable portion 85 in the vertical state, the sheet P2 is folded at an upper end 85A of the movable portion 85. In this state, when the sheet P2 is fed by the roller 16, the upstream end of the sheet P2 in the conveyance direction moves upward toward the upper end 85A, turns downward at the upper end 85A, and then moves forward. In the first illustrative embodiment, an upper end of the roller 87 forms the upper end 85A of the movable portion 85.

As illustrated in FIG. 3, the first opposing surface 86A faces a downstream portion PZ1 of the sheet P2 in the conveyance direction when the sheet P2 is received on the movable portion 85 in the vertical state. The second opposing surface 86B faces away from the first opposing surface 86A and faces an upstream portion PZ2 of the sheet P2 in the conveyance direction. The downstream portion PZ1 refers to a portion of the sheet P2 located downstream of the upper end 85A of the movable portion 85 in the conveyance direction. The upstream portion PZ2 refers to a portion of the sheet P2 located upstream of the upper end 85A of the movable portion 85 in the conveyance direction. The first opposing surface 86A faces upward when the movable portion 85 is in the inclined state.

The main body 86 includes two through-holes 86C (see e.g., FIGS. 4A and 4B). The two through-holes 86C are elongated in the left-right direction and are spaced apart from each other in the vertical direction. Each through-hole 86C extends through the main body 86 in a thickness direction (i.e., the front-rear direction in FIG. 3) and is open at both the first opposing surface 86A and the second opposing surface 86B.

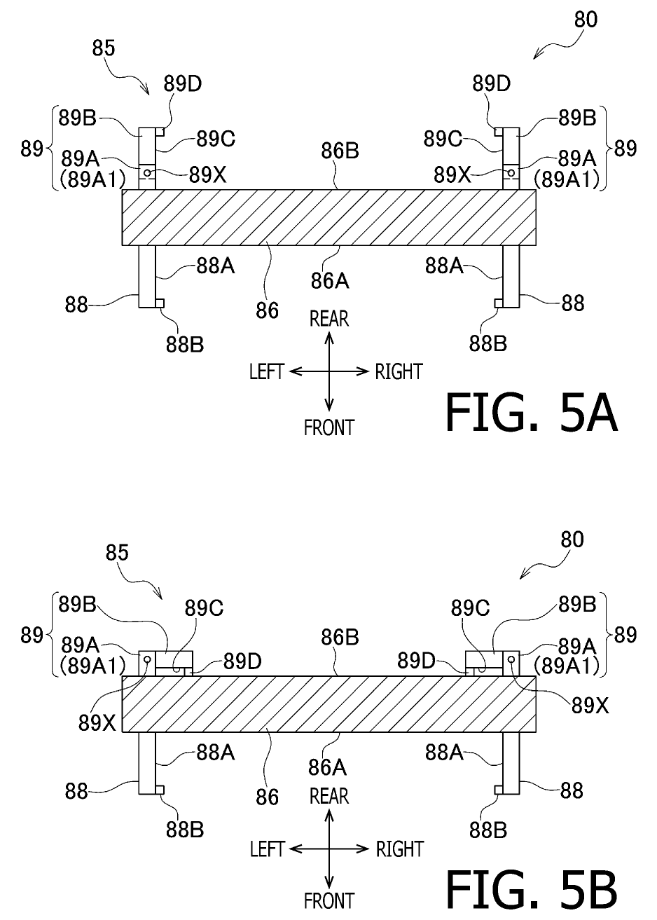

As illustrated in FIGS. 4A and 5A, the side guides 88 are spaced apart from each other in the left-right direction. Each side guide 88 is formed of a plate member extending in both the front-rear direction and the vertical direction. Each side guide 88 has a length extending beyond the two through-holes 86C in the vertical direction. The side guides 88 have respective protrusions 88B that protrude from respective inner surfaces 88A facing each other in the left-right direction. Each protrusion 88B is disposed at a front end portion of the corresponding side guide 88 that is the farthest from the first opposing surface 86A in the front-rear direction. Each protrusion 88B extends in the vertical direction.

As illustrated in FIGS. 4B and 5A, the side guides 89 are spaced apart from each other in the left-right direction. Each side guide 89 includes a base portion 89A and a movable guide portion 89B. Each base portion 89A extends beyond the two through-holes 86C in the vertical direction. Two flanges 89A1 are formed on a rear surface of each base portion 89A. The two flanges 89A1 are disposed at an upper end portion and a lower end portion, respectively, of each base portion 89A in the vertical direction.

Each movable guide portion 89B is formed of a plate member extending in both the front-rear direction and the vertical direction. Each movable guide portion 89B is disposed behind the base portion 89A in the front-rear direction and between the two flanges 89A1 in the vertical direction. Each movable guide portion 89B is supported by the two flanges 89A1 to be pivotable about a shaft 89X extending in the vertical direction.

Each movable guide portion 89B is configured to selectively assume either a first position (see FIG. 5A) or a second position (see FIG. 5B). As illustrated in FIGS. 5A and 5B, when in the second position, each movable guide portion 89B protrudes rearward from the second opposing surface 86B to a lesser extent than when in the first position. Namely, the side guides 89 are foldable and configured to regulate lateral movement of the sheet P2 in the left-right direction when in the first position.

As illustrated in FIG. 5A, the side guides 89 have respective protrusions 89D that protrude from respective inner surfaces 89C facing each other in the left-right direction. Each protrusion 89D is disposed at a rear end portion of the corresponding movable guide portion 89B that is the farthest from the second opposing surface 86B in the front-rear direction when the movable guide portion 89B is in the first position. As illustrated in FIG. 4B, each protrusion 89D extends in the vertical direction.

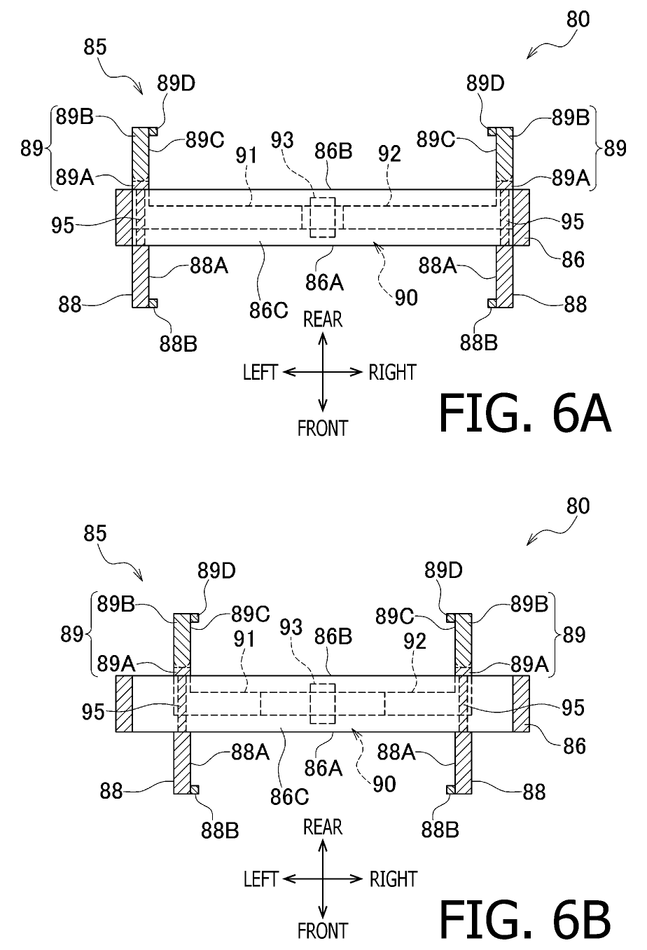

As illustrated in FIGS. 4A, 4B, 6A, and 6B, the left two of the four connecting portions 95 connect the left side guide 88 to the left side guide 89. Likewise, the right two of the four connecting portions 95 connect the right side guide 88 to the right side guide 89. Each connecting portion 95 is disposed within one of the through-holes 86C. With this configuration, when either one of the side guides 88 is moved in either direction along the left-right direction, the corresponding one of the side guides 89 also moves in the same direction. Likewise, when either one of the side guides 89 is moved in either direction along the left-right direction, the corresponding one of the side guides 88 also moves in the same direction.

As illustrated in FIGS. 4A, 4B, 6A, and 6B, the movement mechanism 90 is incorporated in the main body 86 and includes two rack gears 91 and 92 and a pinion gear 93. The two rack gears 91 and 92 extend in the left-right direction and are spaced apart from each other in the vertical direction. The rack gear 91 is connected to the left side guide 89. The rack gear 92 is connected to the right side guide 89. The pinion gear 93 is supported by the main body 86 to be rotatable about a shaft 93X extending in the front-rear direction. The pinion gear 93 is disposed in mesh with teeth on the lower surface of the rack gear 91 and teeth on the upper surface of the rack gear 92. With this configuration, for instance, when the left side guide 89 is moved rightward from the position shown in FIG. 6A to the position shown in FIG. 6B, the other side guides—namely, the side guides 88 and the right side guide 89—also move in conjunction from their positions in FIG. 6A to their positions in FIG. 6B, respectively. That is, when either one of the side guides 88 or 89 (i.e., any one of the side guides 88 or of the side guides 89) is moved, the remaining side guides 88 and 89 move in conjunction with the moved side guide.

The notification device 99 is configured to perform a notification operation to notify the user of information. For instance, as illustrated in FIG. 1, the notification device 99 may include a display provided in the printer 1 and may perform the notification operation by displaying, on the display, information to be notified to the user. In another instance, the notification device 99 may include a speaker provided in the printer 1 and may perform the notification operation by outputting, through the speaker, information to be notified to the user as sound.

### Control for First Printing

Next, control for first printing will be described. The first printing is a printing operation in which an image is recorded on the roll sheet R stored in the roll sheet housing 11. In response to receiving a print command to perform printing on the roll sheet R stored in the roll sheet housing 11, the controller 100 starts control for the first printing. After receiving the print command, the controller 100 first causes the sheet conveyor 3 to start feeding the roll sheet R toward the head 5.

When the roll sheet R reaches a position facing the head 5, the controller 100 controls the driver IC to eject ink from the nozzles onto the roll sheet R, thereby recording an image. Then, when a trailing end portion (i.e., a portion to be cut) of the roll sheet R reaches the cutting position of the cutter 6, the controller 100 controls the sheet conveyor 3 to temporarily stop conveying the roll sheet R.

Next, the controller 100 drives the cutter motor, thereby causing the cutter 6 to cut the roll sheet R. Thereafter, the controller 100 controls the sheet conveyor 3 to discharge a cut roll sheet R (i.e., a cut portion of the roll sheet R that is downstream of the cutter 6 in the conveyance direction) onto the discharge tray 20. Thus, the control for the first printing is completed.

### Control for Second Printing

Subsequently, control for second printing will be described. The second printing is a printing operation in which an image is recorded on a cut sheet stored in the cut sheet housing 12. In response to receiving a print command to perform printing on a cut sheet stored in the cut sheet housing 12, the controller 100 starts control for the second printing. After receiving the print command, the controller 100 first causes the sheet conveyor 3 to start feeding the cut sheet toward the head 5.

When the cut sheet reaches a position facing the head 5, the controller 100 controls the driver IC to eject ink from the nozzles onto the cut sheet, thereby recording an image. Then, the controller 100 controls the sheet conveyor 3 to discharge, onto the discharge tray 20, the cut sheet with the image recorded thereon. Thus, the control for the second printing is completed.

### Control for Third Printing

Next, control for third printing will be described. The third printing is a printing operation in which an image is recorded on a sheet P2 received on the sheet placement assembly 80 with the movable portion 85 in the vertical state. In the first illustrative embodiment, the sheet placement assembly 80 with the movable portion 85 in the vertical state receives a long sheet P2 that is longer than a cut sheet and longer than the first opposing surface 86A in the conveyance direction. Examples of the sheet P2 may include, but are not limited to, a long sheet P on which an image has been recorded on one side in the first printing.

In response to receiving a print command for the third printing including a signal to feed a long sheet P2 received on the sheet placement assembly 80, the controller 100 starts control for the third printing. After receiving the print command including a signal to feed a long sheet P2 received on the sheet placement assembly 80, the controller 100 first causes the notification device 99 to provide information indicating that the movable portion 85 is to be in the vertical state. This enables the user to check whether a sheet P2 has been received on the sheet placement assembly 80 with the movable portion 85 in the vertical state. Then, after receiving information indicating that a sheet P2 has been received on the sheet placement assembly 80 with the movable portion 85 in the vertical state, the controller 100 causes the sheet conveyor 3 to start feeding the sheet P2 toward the head 5.

When the sheet P2 reaches a position facing the head 5, the controller 100 controls the driver IC to eject ink from the nozzles onto the sheet P2, thereby recording an image. The controller 100 then controls the sheet conveyor 3 to discharge, onto the discharge tray 20, the sheet P2 with the image recorded thereon. Thus, the control for the third printing is completed.

### Control for Fourth Printing

Subsequently, control for fourth printing will be described. The fourth printing is a printing operation in which an image is recorded on a sheet P received on the sheet placement assembly 80 with the movable portion 85 in the inclined state. In the first illustrative embodiment, possible examples of the sheet P received on the sheet placement assembly 80 with the movable portion 85 in the inclined state may include, but are not limited to, a cut sheet, a postcard, and an envelope.

In response to receiving a print command for the fourth printing, the controller 100 starts control to perform the fourth printing. After receiving a print command that includes a signal to feed the sheet P received on the sheet placement assembly 80, the controller 100 first causes the notification device 99 to provide information indicating that the movable portion 85 is to be in the inclined state. This enables the user to check whether the sheet P has been received on the sheet placement assembly 80 with the movable portion 85 in the inclined state. Then, after receiving information indicating that the sheet P has been received on the sheet placement assembly 80 with the movable portion 85 in the inclined state, the controller 100 causes the sheet conveyor 3 to start feeding the sheet P on the sheet placement assembly 80 toward the head 5. At this time, the movable portion 85 of the sheet placement assembly 80 is in the inclined state. Therefore, the first opposing surface 86A, which serves as a placement surface for the sheet P, is nearly horizontal, as indicated by the double-dashed chain line in FIG. 2. Accordingly, the sheet P is fed by the roller 16 forward along the nearly horizontal first opposing surface 86A.

When the sheet P reaches a position facing the head 5, the controller 100 controls the driver IC to eject ink from the nozzles onto the sheet P, thereby recording an image. The controller 100 then controls the sheet conveyor 3 to discharge, onto the discharge tray 20, the sheet P with the image recorded thereon. Thus, the control for the fourth printing is completed.

As described above, according to the printer 1 of the first illustrative embodiment, when a sheet P2 that is long in the conveyance direction is conveyed by the roller 16 of the sheet conveyor 3 in a state where the sheet P2 is received on the sheet placement assembly 80 with the movable portion 85 in the vertical state, lateral movement (i.e., movement in the left-right direction) of the upstream portion PZ2 of the sheet P2 is regulated by the side guides 89. In this case, the sheet P2 is less likely to skew in the left-right direction (i.e., to proceed obliquely relative to the conveyance direction) during conveyance than when only the lateral movement of the downstream portion PZ1 is regulated. As a result, skewing of the long sheet P2 is inhibited.

The sheet placement assembly 80 includes the side guides 88. This enables the long sheet P2 to be laterally regulated at both the upstream portion PZ2 and the downstream portion PZ1 of the sheet P2. Accordingly, skewing of the sheet P2 is more reliably inhibited. Furthermore, even when the long sheet P2 received on the sheet placement assembly 80 is conveyed and comes to face the first opposing surface 86A without facing the second opposing surface 86B, the side guides 88 regulate the lateral movement of a portion of the sheet P2 that faces the first opposing surface 86A. This configuration helps inhibit skewing of the sheet P2.

The side guides 89 are configured to move along the left-right direction relative to the main body 86. Thus, the side guides 89 are movable to be adjusted to the length (i.e., the width) of the long sheet P2 in the left-right direction. This configuration helps effectively inhibit skewing during conveyance even for long sheets P2 with various widths.

The side guides 88 are configured to move, relative to the main body 86, along the left-right direction in conjunction with the side guides 89. This configuration allows both of the pair of side guides 88 and the pair of side guides 89 to be adjusted to the length (i.e., the width) of the long sheet P2 in the left-right direction simply by moving either one. Accordingly, the user is allowed to save time and effort compared with a case in which the pair of side guides 88 and the pair of side guides 89 are moved individually.

The movable guide portion 89B of each side guide 89 is configured to selectively assume either the first position or the second position. Accordingly, when no long sheet P2 is received on the sheet placement assembly 80, each side guide 89 may be folded into a state where the corresponding movable guide portion 89B is in the second position, thereby reducing the space otherwise occupied by each movable guide portion 89B in the first position.

The side guides 89 include their respective protrusions 89D. This configuration helps inhibit the long sheet P2 received on the sheet placement assembly 80 from floating from the second opposing surface 86B.

The movable portion 85 includes the roller 87. This configuration helps reduce the conveyance resistance of the folded portion (i.e., the portion in contact with the upper end 85A) of the long sheet P2 received on the sheet placement assembly 80 with the movable portion 85 in the vertical state.

The sheet placement assembly 80 includes the movable portion 85 configured to selectively assume either the vertical state or the inclined state. This configuration allows the user to intuitively set the position of the movable portion 85 to either the vertical state or the inclined state depending on the length of the sheet P in the conveyance direction. That is, to place a long sheet P2, which is longer in the conveyance direction than a cut sheet, on the sheet placement assembly 80, the user may set the movable portion 85 to the vertical state, thereby facilitating placement of the long sheet P2 on the sheet placement assembly 80. On the other hand, to place a short sheet P, which is equal to or shorter than a cut sheet in the conveyance direction, on the sheet placement assembly 80, the user may set the movable portion 85 to the inclined state, thereby facilitating placement of the short sheet P on the sheet placement assembly 80. Thus, the sheet placement assembly 80 is configured to be adjusted as appropriate according to the length of the sheet P in the conveyance direction, thereby enabling conveyance of sheets P of various lengths.

In addition, the sheet P received on the sheet placement assembly 80 with the movable portion 85 in the inclined state is folded less than the sheet P2 received thereon with the movable portion 85 in the vertical state. That is, the sheet P is received in a nearly horizontal state on the sheet placement assembly 80 with the movable portion 85 in the inclined state. As a result, the sheet P is conveyed with stable straightness. Accordingly, when the movable portion 85 of the sheet placement assembly 80 is in the inclined state, relatively thick sheets P, such as postcards and envelopes, are conveyed more easily along the path T2, which extends in a nearly horizontal and linear manner.

In response to acquiring a signal indicating an instruction to convey a long sheet P2 that is longer in the conveyance direction than the first opposing surface 86A, the controller 100 causes the notification device 99 to provide information indicating that the movable portion 85 is to be in the vertical state. This configuration helps reduce the risk of the user mistakenly placing the long sheet P2 on the sheet placement assembly 80 with the movable portion 85 in the inclined state.

### Second Illustrative Embodiment

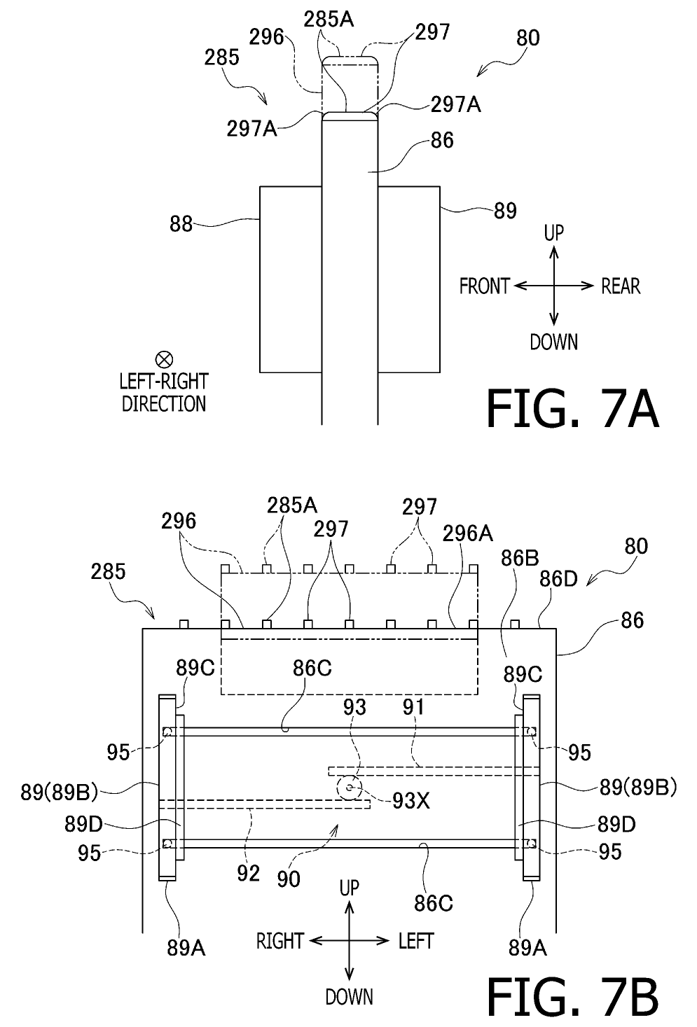

Next, a printer 1 of a second illustrative embodiment according to aspects of the present disclosure will be described with reference to FIGS. 7A and 7B. It is noted that elements having substantially the same configuration as those in the first illustrative embodiment are denoted by the same reference numerals and may not be described in detail again. The printer 1 of the second illustrative embodiment differs from that of the first illustrative embodiment only in the following respect. Specifically, in the second illustrative embodiment, the printer 1 includes a movable portion 285, the configuration of which is slightly different from that of the movable portion 85 in the first illustrative embodiment. More particularly, the movable portion 285 includes the main body 86, the side guides 88, the side guides 89, the movement mechanism 90, and the four connecting portions 95, in substantially the same manner as in the first illustrative embodiment. The movable portion 285 further includes an extension 296 and a plurality of ridges 297, and does not include the roller 87 described above.

The extension 296 is extendable upward from the upper end of the main body 86. The extension 296 extends in both the vertical direction and the left-right direction. The extension 296 is disposed to be movable into and out of the main body 86. The respective lengths of the extension 296 in the vertical direction and the left-right direction are shorter than those of the main body 86. The extension 296 is configured to selectively assume either a retracted state (indicated by solid lines in FIGS. 7A and 7B) or an extended state (indicated by double-dashed chain lines in FIGS. 7A and 7B). In other words, the extension 296 is movable between the retracted state and the extended state. In the retracted state, the upper end of the extension 296 is flush with the upper end of the main body 86. In the extended state, the upper end of the extension 296 protrudes upward beyond the upper end of the main body 86.

The ridges 297 are located side by side in the left-right direction on an upper end surface 86D of the main body 86 and an upper end surface 296A of the extension 296. Each ridge 297 protrudes upward from the upper end surface 86D or the upper end surface 296A and extends in the front-rear direction. In addition, as illustrated in FIG. 7A, a rounded corner 297A is formed at opposite end portions (i.e., a front end portion and a rear end portion) of each ridge 297 in the front-rear direction.

Thus, the sheet placement assembly 80 includes the ridges 297 configured to serve as upper end portions 285A of the movable portion 285 when the movable portion 285 is in the vertical state. This configuration helps reduce the conveyance resistance of the folded portion (i.e., the portion in contact with the upper end portions 285A of the ridges 297) of the long sheet P2 received on the sheet placement assembly 80.

The sheet placement assembly 80 further includes the extension 296. By extending the extension 296 from the retracted state to the extended state, the upstream end, in the conveyance direction, of the long sheet P2 received on the sheet placement assembly 80 is raised farther from the installation surface G on which the printer 1 is placed, by an amount corresponding to the extended length of the extension 296. As a result, the upstream end of the long sheet P2 in the conveyance direction is less likely to come into contact with the installation surface G. Accordingly, the sheet P2 is inhibited from becoming soiled.

While aspects of the present disclosure have been described in conjunction with various example structures outlined above and illustrated in the drawings, various alternatives, modifications, variations, improvements, and/or substantial equivalents, whether known or that may be presently unforeseen, may become apparent to those having at least ordinary skill in the art. Accordingly, the example embodiment(s), as set forth above, are intended to be illustrative of the technical concepts according to aspects of the present disclosure, and not limiting the technical concepts. Various changes may be made without departing from the spirit and scope of the technical concepts according to aspects of the present disclosure. Therefore, the disclosure is intended to embrace all known or later developed alternatives, modifications, variations, improvements, and/or substantial equivalents. Some specific examples of potential modifications according to aspects of the present disclosure are provided below.

### Modifications

In the aforementioned illustrative embodiments, the printer 1, serving as a conveyance apparatus, includes the head 5. However, the conveyance apparatus may not necessarily include the head 5, provided that it includes at least the roller 16, the sheet placement assembly 80, the notification device 99, and the controller 100. Furthermore, the conveyance apparatus may not necessarily include the controller 100 configured to cause the notification device 99 to provide a notification, provided that it includes at least the roller 16 and the sheet placement assembly 80.

The sheet placement assembly 80 in each illustrative embodiment may not necessarily include the side guides 88. In addition, the sheet placement assembly 80 in each illustrative embodiment may not necessarily include the movement mechanism 90. Furthermore, the sheet placement assembly 80 in each illustrative embodiment may not necessarily include the four connecting portions 95.

The movement mechanism 90 may have any configuration, provided that moving one of the side guides 88 or 89 (i.e., any one of the side guides 88 or of the side guides 89) enables the remaining side guides 88 and 89 to move in conjunction with the moved side guide.

The side guides 89 may be fixed to the main body 86 and be immovable in the left-right direction. In another instance, the side guides 89 may be configured to move in a particular direction that intersects both the conveyance direction and the left-right direction. In addition, the side guides 89 may be non-foldable. Furthermore, the side guides 89 may not necessarily include respective protrusions 89D. It is noted that the number of the side guides 89 is not limited to two and may exceed two. That is, the sheet placement assembly 80 may include a plurality of side guides 89. Likewise, the number of the side guides 88 is not limited to two and may exceed two. That is, the sheet placement assembly 80 may include a plurality of side guides 88.

The sheet placement assembly 80 in the first illustrative embodiment may not necessarily include the roller 87. The sheet placement assembly 80 in the second illustrative embodiment may not necessarily include the extension 296 or the ridges 297.

Examples of the sheet medium are not limited to paper but may also include cloth and plastic film. In other words, the sheet medium may be formed of any material.

The head 5, serving as a recording device, may be configured to eject a liquid (e.g., a processing liquid that causes components of the ink to aggregate or precipitate) other than ink. Applicable methods for the recording device are not limited to a liquid ejection method but may also include a laser method and a thermal transfer method.

Examples of devices or apparatuses to which aspects of the present disclosure are applicable are not limited to printers but may also include facsimile machines, copiers, and multi-function peripherals.

The following provides examples of associations between elements set forth in the aforementioned illustrative embodiment(s) and modification(s), and elements claimed according to aspects of the present disclosure. For instance, the printer 1 may be an example of a “conveyance apparatus” according to aspects of the present disclosure. The sheet placement assembly 80 may be an example of a “sheet placement assembly” according to aspects of the present disclosure. The sheet conveyor 3 may be an example of a “sheet conveyor” according to aspects of the present disclosure. The first opposing surface 86A may be an example of a “first opposing surface” according to aspects of the present disclosure. The second opposing surface 86B may be an example of a “second opposing surface” according to aspects of the present disclosure. The side guides 89 may be included as examples of “a plurality of first regulation members” according to aspects of the present disclosure. The side guides 88 may be included as examples of “a plurality of second regulation members” according to aspects of the present disclosure. The side guides 89 having respective protrusions 89D that protrude from respective inner surfaces 89C facing each other in the left-right direction may be examples of “a plurality of first regulation members having respective protrusions that protrude from respective inner surfaces facing each other in a particular direction” according to aspects of the present disclosure. The roller 87 of the sheet placement assembly 80 may be an example of a “roller” of the “sheet placement assembly” according to aspects of the present disclosure. The plurality of ridges 297 may be an example of “a plurality of ridges” according to aspects of the present disclosure. The extension 296 may be an example of an “extendable portion” according to aspects of the present disclosure. The notification device 99 may be an example of a “notification device” according to aspects of the present disclosure. The controller 100 may be an example of a “controller” according to aspects of the present disclosure.

What is claimed is:

1. A conveyance apparatus comprising:
a sheet placement assembly configured to, when in a first state where the sheet placement assembly extends in a vertical direction, receive a sheet medium in a folded manner at an upper end of the sheet placement assembly; and
a sheet conveyor configured to convey the sheet medium on the sheet placement assembly in a conveyance direction,
wherein the sheet placement assembly comprises:
a first opposing surface that faces a downstream portion, in the conveyance direction, of the sheet medium on the sheet placement assembly in the first state;
a second opposing surface that faces away from the first opposing surface and faces an upstream portion, in the conveyance direction, of the sheet medium on the sheet placement assembly in the first state; and
a plurality of first regulation members disposed such that the upstream portion of the sheet medium, facing the second opposing surface, is between the plurality of first regulation members in a particular direction intersecting the conveyance direction, the plurality of first regulation members being configured to regulate movement of the sheet medium in the particular direction.

2. The conveyance apparatus according to claim 1,
wherein the sheet placement assembly further comprises a plurality of second regulation members disposed such that the downstream portion of the sheet medium, facing the first opposing surface, is between the plurality of second regulation members in the particular direction, the plurality of second regulation members being configured to regulate movement of the sheet medium in the particular direction.

3. The conveyance apparatus according to claim 1,
wherein the plurality of first regulation members are movable along the particular direction relative to the sheet placement assembly.

4. The conveyance apparatus according to claim 3,
wherein the sheet placement assembly further comprises a plurality of second regulation members disposed such that the downstream portion of the sheet medium, facing the first opposing surface, is between the plurality of second regulation members in the particular direction, the plurality of second regulation members being configured to regulate movement of the sheet medium in the particular direction, and
wherein the plurality of second regulation members are movable along the particular direction relative to the sheet placement assembly in conjunction with the plurality of first regulation members.

5. The conveyance apparatus according to claim 1,
wherein each first regulation member is foldable and configured to selectively assume one of:
a first position to regulate movement of the sheet medium in the particular direction; or
a second position in which each first regulation member protrudes to a lesser extent from the second opposing surface than in the first position.

6. The conveyance apparatus according to claim 1,
wherein the plurality of first regulation members comprise:
respective inner surfaces that face each other in the particular direction; and
respective protrusions that protrude from the respective inner surfaces and are spaced apart from the second opposing surface.

7. The conveyance apparatus according to claim 1,
wherein the sheet placement assembly further comprises a roller configured to serve as the upper end of the sheet placement assembly in the first state and to rotate about a rotation shaft extending in the particular direction.

8. The conveyance apparatus according to claim 1,
wherein the sheet placement assembly further comprises a plurality of ridges configured to serve as the upper end of the sheet placement assembly in the first state, the ridges being arranged in the particular direction and extending in the conveyance direction.

9. The conveyance apparatus according to claim 1,
wherein the sheet placement assembly further comprises an extendable portion configured to extend upward and raise the upper end of the sheet placement assembly in the first state.

10. The conveyance apparatus according to claim 1,
wherein the sheet placement assembly is further configured to selectively assume either the first state or a second state where the first opposing surface faces upward.

11. The conveyance apparatus according to claim 10, further comprising:
a notification device; and
a controller configured to cause the notification device to provide information indicating that the sheet placement assembly is to be in the first state, in response to receiving a signal indicating an instruction to convey a long sheet medium that is longer in the conveyance direction than the first opposing surface.
